(19) United States
(12) Patent Application Publication
(10) Pub. No.: US 2024/0100651 A1
(43) Pub. Date: Mar. 28, 2024

(54) ABRASIVE WATERJET CUTTING NOZZLE WITH A RESISTIVE STRAIN GAUGE SENSOR

(71) Applicant: UNIVERSITÉ DU LUXEMBOURG, Esch-sur-Alzette (LU)

(72) Inventor: Edoardo COPERTARO, Luxembourg Ville (LU)

(21) Appl. No.: 18/257,805

(22) PCT Filed: Dec. 15, 2021
(86) PCT No.: PCT/EP2021/085908

§ 371 Date: Jun. 15, 2023

(30) Foreign Application Priority Data
Dec. 16, 2020 (LU) 102298

(51) Int. Cl. B24C 5/04; B24C 1/04; G01H 11/06

(52) U.S. Cl. CPC B24C 5/04; B24C 1/045; G01H 11/06

(57) ABSTRACT

The invention provides a nozzle (2) for abrasive waterjet cutting. The nozzle (2) comprises: a body (4) comprising an outer surface (6); a passage (8) through the body, said passage comprising: in inlet section, an outlet section and a passage direction (14), said passage being configured for guiding an abrasive waterjet. A resistive strain gauge sensor (20) comprises a sensitivity direction (22) along the passage direction. The outer surface is circular and presents a planar area (40) for the sensor which is connected by a Wheatstone bridge. The invention also provides an abrasive waterjet nozzle manufacturing method. The invention also provides a use of a strain gauge sensor attached to a nozzle for abrasive waterjet cutting, for measuring bending vibrations.

### TECHNICAL FIELD

The invention pertains to waterjet cutting, notably abrasive waterjet cutting. The invention lies in the domain of vibration sensing and wear monitoring. More precisely, the invention provides a nozzle for an abrasive waterjet cutting system, said nozzle being equipped with at least one strain gauge sensor configured for measuring bending vibrations. The invention also provides a manufacturing method for said abrasive waterjet cutting nozzle. The invention further provides a use of a strain gauge sensor attached to a nozzle for an abrasive waterjet cutting system, for measuring bending vibrations.

### BACKGROUND OF THE INVENTION

Abrasive waterjet cutting technology permits to cut hard materials such as alloys and stones. This manufacturing process is peculiarly interesting for several of its features, of which one particularly relevant is the absence of a heat affected zone on the workpiece, during cutting operations. Thus, this process does not affect the intrinsic properties of the material workpiece along the cutting contour. This benefit is highly appreciated in the aeronautic domain where homogeneous material properties are closely connected to reliability. Further features of abrasive waterjet cutting contribute to provide an edge with respect to alternative technologies and these include lower initial investment, no limitations in shape complexity, no mechanical contact with physical tools, narrow kerf, negligible blurs, good edge sharpness.

This manufacturing technology requires a high-pressure water source and an abrasive medium, notably particles made of hard material. High-pressure water is accelerated through the primary orifice, resulting in a high-speed water jet. Particles are fed with air into a mixing chamber. The resulting mixture travels through a tube, also known as “nozzle” or “focuser”, where momentum transfer from the waterjet to particles occurs, the latter being consequently accelerated. The nozzle constitutes a critical part of an abrasive waterjet cutting system; the component is made of hard tungsten carbide or boron carbide and its inner diameter typically ranges between 0.5 mm and 2.0 mm; its primary scope is to stabilize the flow formed in the mixing chamber, transfer momentum to the abrasive particles and create a focused, consistent, high-velocity, particle-laden abrasive jet. At the outlet of the nozzle, the abrasive jet gets airborne, impinges on the workpiece and progressively erodes the workpiece due to repeated collisions of the abrasive particles.

During operation, an abrasive waterjet (AWJ) cutting system generally generates dusts, vibrations, noise, and projections. Some of these parameters are conveniently used by monitoring devices for controlling the cutting operation, the workpiece quality or for troubleshooting of the AWC system. For instance; the wear state of the nozzle may be monitored. Analogous monitoring may be carried out with respect to the primary orifice wear state. A misalignment between the primary orifice and the nozzle may also be detected.

For these monitoring purposes, different kinds of sensors may be used. Amongst other sensors, a strain gauge may be considered.

The document WO2020/128090 A1 teaches an abrasive waterjet cutting system comprising a nozzle and strain gauge sensors. This system provides an accurate monitoring. However, there is still room for improvement.

### Technical Problem to be Solved

It is an objective of the invention to present an abrasive waterjet cutting nozzle which overcomes at least some of the disadvantages of the prior art. In particular, it is an objective of the invention to improve the vibration measurement accuracy.

### SUMMARY OF THE INVENTION

According to a first aspect of the invention it is provided a nozzle for abrasive waterjet cutting, the nozzle comprising: a body comprising an outer surface; a passage through the body, said passage comprising: in inlet section, an outlet section and a passage direction, said passage being configured for guiding an abrasive waterjet; at least one strain gauge sensor comprising a sensitivity direction along the passage direction.

Preferably, the nozzle may comprise an inclination angle α between the passage direction and the sensitivity direction which is of at most 30°.

Preferably, the strain gauge sensor may comprise a patterned layer and an insulating layer.

Preferably, the patterned layer comprise a metallic foil patterned layer.

Preferably, the strain gauge sensor may be physically in contact of the body.

Preferably, the patterned layer may comprise a serpentine structure with parallel sensing portions which comprise a main portion direction, said portion direction being parallel to the passage direction.

Preferably, the body may comprise a conical section at the outlet section; along the passage the at least one strain gauge sensor is at distance from the conical section.

Preferably, the conical section may define a geometrical conical surface extending along the at least one strain gauge sensor, said at least one strain gauge sensor being within the geometrical conical surface, perpendicularly to the passage direction the at least one strain gauge sensor is optionally at distance from geometrical conical surface.

Preferably, the outer surface may be generally cylindrical and comprises a planar area, the strain gauge sensor being arranged on said planar area.

Preferably, the planar area may define a recess on the body, the recess comprising a recess depth which is at least two time greater than the combined thicknesses of a strain gauge sensor patterned layer thickness and a strain gauge sensor insulating layer thickness, and optionally a adhesive layer thickness.

Preferably, the at least one strain gauge sensor may comprise a first strain gauge sensor with a first sensitivity direction, and a second strain gauge sensor with a second sensitivity direction, the first strain gauge sensor and the second strain gauge sensor optionally being at opposite positions with respect to the passage.

Preferably, the planar area may be a first planar area, the outer surface further may comprise a second planar area, the second strain gauge sensor may be fixed on said second planar area.

Preferably, the nozzle may comprise a protective layer covering the at least one strain gauge sensor.

Preferably, the protective layer may comprise polymer, optionally epoxide.

Preferably, the passage may be a water passage, such as an abrasive waterjet passage.

Preferably, the inner width of the passage is measured along a main section of constant diameter of the water passage.

Preferably, the recess may be arranged in a downstream half of the body, or the upstream half of the body, with respect to the passage direction.

Preferably, the electrically insulating layer may be wider than the electrically active layer.

Preferably, the electrically active layer may be an electric resistance and/or may comprise a resistance of at least: 100Ω, or 120Ω; and/or at most: 500Ω; or 300Ω, or 200Ω.

Preferably, the outer surface may comprise a recess, the strain gauge sensor being arranged in said recess.

Preferably, the body may comprise a flat surface, the strain gauge sensor may be arranged on said flat surface.

Preferably, the electrically active layer of the strain gauge sensor may be arranged in a downstream half of the body, and/or along the water passage the electrically insulating layer is at distance from the downstream half of the body.

Preferably, the inner width may be an inner diameter; and/or an average diameter.

Preferably, the electrically active layer is electrically conducting.

Preferably, the sensing portions may be parallel to each other and parallel to the sensitivity direction.

Preferably, the sensitivity direction is tangential to the outer surface.

Preferably, the planar area may comprise a downstream half and an upstream half; the strain gauge sensor being arranged in the downstream half.

Preferably, the strain gauge sensors may be arranged at a downstream half of the body.

The sensitivity direction of the strain gauge is not an essential aspect of the invention. It is another aspect of the invention to provide a nozzle for waterjet cutting machine, optionally an abrasive waterjet cutting machine, the nozzle comprising:
a body;
an outer surface;
a passage through the body and configured for guiding a waterjet, said water passage comprising a passage direction and an inner width;
a strain gauge sensor comprising an electrically insulation layer and an electrically active layer, the electrically active layer comprises:
a width which represents at least: 50%, or 100%, of the inner width;
and/or
the body comprises a flat surface and a passage connection of same width than the passage which extends from the passage to the flat surface, the active layer extends on: 1% to 500%; or 80% to 400%, or 100% to 200%, or 1% to 100%, or 10% to 50%, of the width of the passage connection; values included.

It is another aspect of the invention to provide a monitoring process of a nozzle for abrasive waterjet cutting, the monitoring process comprising: providing a nozzle comprising: a body comprising an outer surface; a passage through the body, said passage comprising a passage direction and being configured for guiding an abrasive waterjet, a strain gauge strain gauge sensor comprising a sensitivity direction oriented along the passage direction;
measuring, by means of the strain gauge sensor, vibration data of the nozzle during cutting operation;
identifying a natural frequency of the nozzle in the vibration data;
identifying a natural frequency shift of said natural frequency;
generating a wear signal if the natural frequency shift meets a predefined condition, the nozzle optionally being in accordance with the invention.

It is another aspect of the invention to provide a wear monitoring process of a nozzle for abrasive waterjet cutting, the wear monitoring process comprising:
providing a nozzle; optionally in accordance with the invention;
measuring, by means of the nozzle, first vibration data of the nozzle during an abrasive waterjet cutting period;
identifying a first natural frequency by means the first vibration data; comparing the first natural frequency with reference frequency;
generating a wear signal if the first natural frequency differs from the reference frequency of a predefined frequency threshold.

Preferably, the predefined condition may comprise a frequency shift of at least: 50 Hz, or 100 Hz.

Preferably, the nozzle may comprise a rest natural frequency at a rest state which is higher, preferably at least twice as height, than the natural frequency identified during the step of identifying a natural frequency.

Preferably, the vibration data may comprise a frequency peak in the correspondence of the natural frequency.

It is another aspect of the invention to provide a manufacturing method of a nozzle for abrasive waterjet cutting, the method comprising: providing a nozzle for abrasive waterjet cutting, the nozzle comprising: a body comprising an outer surface; a passage through the body, said passage comprising an inlet section, an outlet section, and a passage direction, said passage being configured for guiding an abrasive waterjet; providing at least one strain gauge sensor comprising a sensitivity direction; aligning the sensitivity direction along the passage direction; fixing the at least one strain gauge sensor on the outer surface.

Preferably, the manufacturing method may further comprise a step machining in order to form a planar area on the outer surface, at step fixing the strain gauge sensor is fixed on said planar area.

Preferably, step fixing may comprise gluing the strain gauge sensor on the outer surface.

Preferably, after step fixing, the manufacturing method may further comprise a step applying a protective layer on the at least one strain gauge sensor and on the outer surface.

Preferably, the process further may comprise a step smoothing sensor area of the outer surface, at step fixing the at least one strain gauge sensor being fixed at said smoothed area.

It is another aspect of the invention to provide a use of a at least one strain gauge sensor comprising a sensitivity direction configured for sensing vibrations of a nozzle for abrasive waterjet cutting, said nozzle comprising: a body comprising an outer surface; a passage through the body, said passage comprising: an inlet section, an outlet section, and a passage direction; said passage being configured for guiding an abrasive waterjet; the nozzle optionally being in accordance with the invention.

Preferably, the at least one strain gauge sensor may comprise at least two strain gauge sensors with sensitivity directions parallel to the passage direction; and/or at least one or each of the sensitivity directions is inclined, of an inclination angle, with respect to the passage direction.

Preferably, the at least one strain gauge sensors may be electrically connected to a Wheatstone bridge.

It is another aspect of the invention to provide a use of a Wheatstone bridge for connecting at least one, or at least two, or at least four strain gauge sensors configured for sensing vibrations of a nozzle for abrasive waterjet cutting, each strain gauge sensor comprising a sensitivity direction;
said nozzle comprising:
a body comprising an outer surface;
a passage through the body,
said passage comprising: an inlet section, an outlet section, and a passage direction;
said passage being configured for guiding an abrasive waterjet; the nozzle optionally being in accordance with the invention.

It is another object of the invention to provide a nozzle laminate structure, said nozzle laminate structure comprising a planar surface of the nozzle body, an adhesive layer, an electrically insulating layer, an electrically active layer, and optionally a protective layer, said layers being arranged as listed.

The different aspects of the invention may be combined to each other. In addition, the preferable features of each aspect of the invention may be combined with the other aspects of the invention, unless the contrary is explicitly mentioned.

### Technical Advantages of the Invention

The invention provides a sensor arrangement with an increased sensitivity. The orientation of the sensitivity direction contributes to measuring an accurate vibration signal. It is optimal for monitoring and detecting a frequency shift correlated to a worn state of the nozzle.

The body, and notably the outer surface, is adapted for protecting the sensor. Then the latter is protected against the aggressive environment of abrasive waterjet cutting. The nozzle monitoring is simplified.

### BRIEF DESCRIPTION OF THE DRAWINGS

Several embodiments of the present invention are illustrated by way of figures, which do not limit the scope of the invention, wherein:

FIG. 1 provides a schematic illustration of a nozzle in accordance with a first preferred embodiment of the invention;

FIG. 2 provides a schematic illustration of a nozzle in accordance with a second preferred embodiment of the invention;

FIG. 3 provides a schematic illustration of a nozzle in accordance with a third preferred embodiment of the invention;

FIG. 4 provides a schematic illustration of a nozzle in accordance with a fourth preferred embodiment of the invention;

FIG. 5 provides a schematic illustration of a nozzle in accordance with a fifth preferred embodiment of the invention;

FIG. 6 provides a schematic illustration of a nozzle in accordance with a sixth preferred embodiment of the invention;

FIG. 7 provides a schematic illustration of a nozzle in accordance with a seventh preferred embodiment of the invention;

FIG. 8 provides a schematic illustration of a manufacturing method of a nozzle in accordance with a preferred embodiment of the invention;

FIG. 9 provides a schematic illustration of a wear monitoring process of a nozzle in accordance with a preferred embodiment of the invention;

FIG. 10 provides an illustration of the power spectral density curve of a nozzle equipped with an accelerometer;

FIG. 11 provides an illustration of the power spectral density curve of a nozzle in accordance with a preferred embodiment of the invention;

FIG. 12 provides an illustration of a natural frequency shift of a nozzle in accordance with a preferred embodiment of the invention.

### DETAILED DESCRIPTION OF THE INVENTION

This section describes the invention in further details based on preferred embodiments and on the figures. Identical reference numbers will be used to describe similar or the same concepts throughout different embodiments of the invention.

It should be noted that features described for a specific embodiment described herein may be combined with the features of other embodiments unless the contrary is explicitly mentioned. Features commonly known in the art will not be explicitly mentioned for the sake of focusing on the features that are specific to the invention. For example, the nozzle in accordance with the invention is evidently in fluid flow communication with a fluid supply, even though such supply is not explicitly referenced on the figures nor referenced in the description.

In the following description, the words “downstream” and “upstream” are considered in relation with the abrasive waterjet flow direction. These words also apply before the abrasive waterjet flow starts, and after the workpiece.

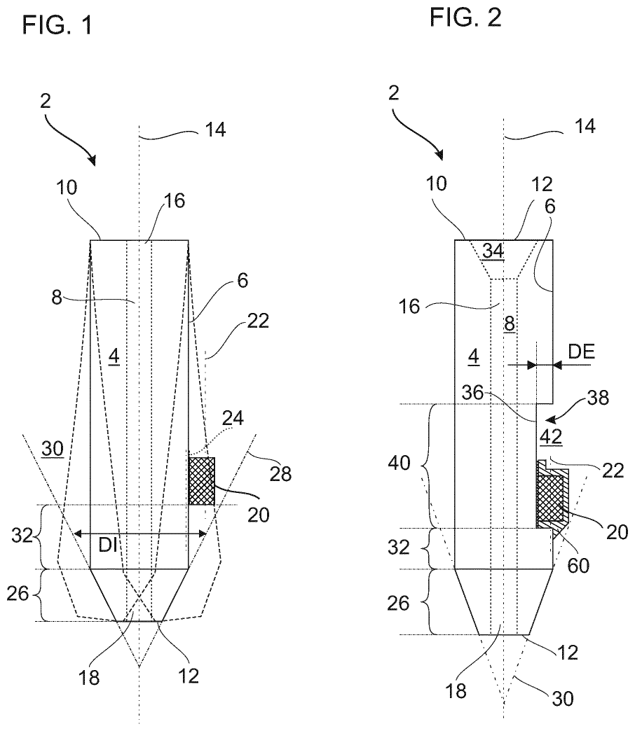

FIG. 1 shows a nozzle 2 for abrasive waterjet cutting in accordance with a preferred embodiment of the invention. The nozzle 2 is intended to be mounted in an abrasive waterjet cutting system (not represented). The nozzle 2 is configured for stabilizing the mixture formed in the mixing chamber, transferring momentum to the abrasive particles and creating a focused, consistent, high-velocity, particle-laden abrasive waterjet. The nozzle 2 is configured for resisting to cutting conditions with a water pressure up to 6000 bars. During operation, the nozzle 2 is exposed to erosion action from the abrasive particles enclosed in the waterjet.

The nozzle 2 comprises a body 4. The body 4 may be a main body. The body 4 comprises an outer surface 6. The outer surface 6 is generally circular. The outer surface 6 may comprise a cylindrical side surface, or cylindrical envelop. The body 4 is generally cylindrical. The body may be made of hard metal, notably tungsten carbide or boron carbide, in order to resist to abrasive particles. The nozzle 2 further comprises a passage 8, such as an abrasive waterjet passage. The passage 8 is configured for guiding the abrasive waterjet. The passage 8 crosses the body 4, and is surrounded by the outer surface 6. The passage 8 extends through the body 4 from the upstream end 10 to the downstream end 12. The upstream 10 end is intended to be fixed to cutting head of the abrasive waterjet cutting system (not represented), whereas the downstream end 12 is intended to point toward a workpiece to cut. The downstream end 12 may be considered as a free end. The passage 8 is generally cylindrical and its diameter typically ranges from 0.5 mm to 2.0 mm. Due to erosion action from abrasive particles, said inner diameter increases progressively, as operating hours are accumulated. The nozzle 2 requires replacement at certain intervals, for example every 100 hours of operation, due to the progressive increase of said inner diameter,

Any continuous body is characterized by infinite vibration modes. A vibration mode is a harmonic oscillation of a continuous body, in which potential energy is converted into kinetic energy and vice versa. A vibration mode is characterized by its mode shape, mode frequency, and mode damping: the first is the oscillation pattern; the second is the oscillation frequency; the third is related with the attenuation versus time of the oscillation. The vibration mode of a continuous body that occurs at the lowest mode frequency can be referred to as the first vibration mode of that continuous body. The vibration mode of a continuous body that occurs at the second lowest mode frequency can be referred to as the second vibration mode of that continuous body. The vibration modes are properties of the body's geometry, its material properties and its constraints.

The nozzle 2 shown in FIG. 1 includes at least one strain gauge sensor 20 attached on its outer surface 6. The nozzle 2 and the attached at least one strain gauge sensor 20 constitute an assembly that can be referred to as an “instrumented nozzle”. The passage 8 comprises a passage direction 14. The passage direction 14 may be a passage axis; i.e., a geometric line. The instrumented nozzle may be axial-symmetric about the passage direction 14; notably about the passage axis. The passage 8 further comprises an inlet section 16 and an outlet section 18 which is at the opposite from the inlet section 16 with respect to the passage direction 14.

During cutting operation, the instrumented nozzle vibrates. As a consequence, the downstream end 12 vibrates.

The nozzle 2 is represented with dashed lines in its bent configurations. The bending vibrations of the instrumented nozzle entail deformations parallel to the passage direction 14. It is also noteworthy to underline that during operation, the nozzle temperature reaches 80° C. The rigid vibrations do not entail deformations of the instrumented nozzle.

The at least one strain gauge sensor 20 of the instrumented nozzle may be used to sense and monitor bending vibrations during operation. The strain gauge sensor 20 may optionally be a resistive strain gauge sensor 20. The at least one strain gauge sensor 20 comprises a sensitivity direction 22. The sensitivity direction 22 is arranged along the passage direction 14. Arranging the sensitivity direction 22 along the passage direction 14 improves the sensitivity of measurements. The resistive strain gauge sensor 20 is more sensitive to the bending vibrations of the instrumented nozzle. This configuration allows an improved sensitivity to the bending vibrations of the instrumented nozzle, in particular its first bending vibration and possibly its correspondent twin. These bending vibrations may be at about 1200 Hz.

The arrangement in accordance with the invention provides relevant vibration signals for monitoring the wear state of the nozzle. A criterion for deciding on replacement of the nozzle is easier to compute.

The resistive strain gauge sensor 20 is fixed to the outer surface 6. An adhesive film 24 may be used or gluing. Thus, a rigid connection is obtained, between the sensor and the nozzle. This fixation also offers a compact solution.

The body 4 comprises a conical section 26 at the downstream end 12. The conical section 26 comprises a diameter reduction toward the downstream end 12. The conical section 26 defines a conical surface 28. The conical surface 28 is a geometrical surface extending beyond the downstream end 12, along the passage direction 14. The geometrical surface extends upstream, and along the strain gauge sensor 20. Upstream the conical section 26, the conical surface 28 comprises a diameter DI which is greater than the width of the body 4. The conical surface 28 defines a conical space 30, or protected space. The conical space 30 is considered as providing a protection against backscattered droplets and abrasive particles. Indeed, during operation, the backscattered droplets and abrasive particles are deflected by the physical surface of the conical section 26.

The resistive strain gauge sensor 20 is preferably arranged within the conical space 30. Thus, is it protected from the aggressive mist. The resistive strain gauge sensor 20 is preferably at distance from the conical surface 28. There, it is protected at a wider extent form particles. Accordingly, during operation, the resistive strain gauge sensor 20 does not suffer from the mechanical impact of droplets and particles. The life span of the resistive strain gauge sensor 20 is longer.

In order to protect further the resistive strain gauge sensor 20, the nozzle may comprise a separation 32. Along the passage direction 14, the separation 32 is between the conical section 26 and the strain gauge sensor 20. Thus, the separation 32 may offer a safety distance measured at the downstream face of the resistive strain gauge sensor 20.

FIG. 2 shows a nozzle 2 for abrasive waterjet cutting in accordance with a preferred embodiment of the invention. The current embodiment is similar to the previous one.

The nozzle 2 comprises a body 4 and an outer surface 6 which is generally cylindrical. A passage 8 is housed by the body 4. The passage 8 comprises a passage direction 14, an inlet section 16 and an outlet section 18 at the upstream end 10 and at the upstream end 12 respectively. As an option, the nozzle 2 comprises a hoper 34 at the upstream end 10. It is in fluid flow connection with the inlet section 16 of the passage 8. The passage 8 is a straight passage. It may be of constant inner width, notably with a constant inner diameter.

The outer surface 6 is generally circular. The outer surface 6 forms the skin of the body 4. The outer surface 6 is generated by sliding a circular curve along the passage direction 14. The body 4 may be a profiled body. The outer surface 6 comprises a section variation. The body 4 exhibits, locally, a flat surface 36, or flat facet. The flat surface 36 defines a section of reduced thickness 38.

The outer surface 6 includes a planar area 40. The planar area 40 may be considered as a sensor area; intended to receive at least one sensor. Along the passage direction 14, the resistive strain gauge sensor 20 is arranged in the section of reduced thickness 38. The resistive strain gauge sensor 20 is fixed in the planar area 40. The resistive strain gauge sensor 20 protrudes, perpendicularly to the passage direction 14, from the flat surface 36. Its sensitivity direction 22 is along the flat surface 36. The major dimension of the flat area may be along to the passage direction. The sensitivity direction 22 is along the passage direction 14. The planar area 40 forms a recess 42 in the body 42. The sensitivity direction 22 is along the passage 8. The inclination between the sensitivity direction 22 and the passage direction 14 may be of at most 30°. As an option the height of the strain gauge sensor 20 is greater than the depth DE of the recess 42. The planar area 40 is at distance from the conical section 26. The separation 32 separates the planar area 40; notably the section of reduced thickness 38; from the conical section 26. The respective position of the strain gauge sensor 20, at the bottom of the planar area 40, deep in the recess 42; fosters the physical protection. The separation 32 forms a raised portion in front of the sensor 20. It defines a fence blocking liquid and solid spatters; thereby helping protecting the sensor 20. The current solution provides a compromise between protection and cost in the context of a nozzle with a life span generally ranging from 50 hours to 150 hours.

Providing a planar area 40 along the nozzle changes its natural frequencies. It generally lowers these frequencies, which are then easier to measure and monitor. Therefore, it becomes easier to detect a frequency shift due to wear. The nozzle monitoring is simplified.

As an option, the nozzle 2 comprises a protective layer 60. The protective layer 60 may encapsulate the strain gauge sensor 20. The protective layer 60 may fill the planar area 40. The protective layer 60 may comprise polymer, such as epoxide. The strain gauge sensor 20, and optionally the protective layer 60, are within the conical surface 28. The nozzle 2, the strain gauge sensor 20 and the protective layer 60 constitute an assembly that can be referred to as “instrumented nozzle”.

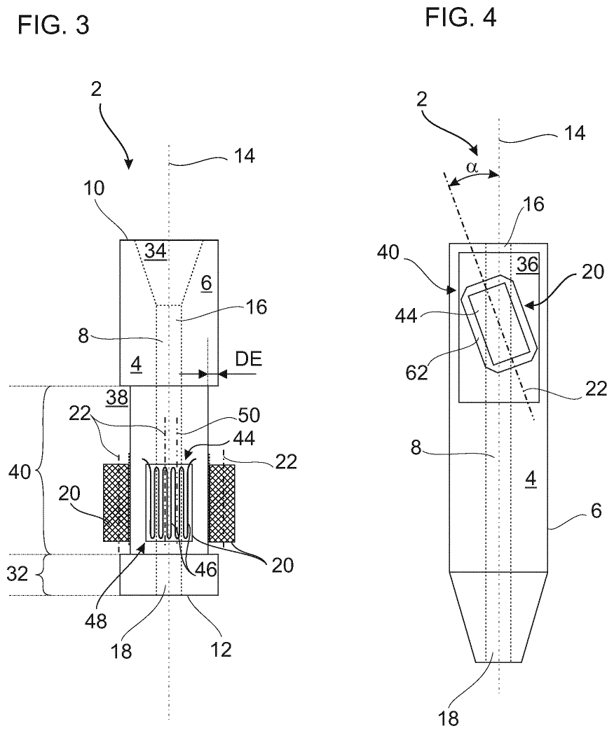

FIG. 3 provides a schematic illustration of a nozzle 2 for abrasive waterjet cutting in accordance with a preferred embodiment of the invention. The current embodiment is similar to the nozzles presented in relation with the previous figures.

The nozzle 2 comprises a body 4 and an outer surface 6 which is generally cylindrical. A passage 8 is housed by the body 4. The passage 8 comprises a passage direction 14, an inlet section 16 and an outlet section 18 at the upstream end 10 and at the upstream end 12 respectively.

The nozzle 2 comprises sensing means. The sensing means may be acceleration sensing means. The sensing means are adapted for sensing vibrations. The nozzle 2 comprises at least one resisitive strain gauge sensor 20, preferably at least two resistive strain gauge sensors 20. In the current illustration, three strain gauge sensors 20 are represented. The nozzle 2 may additionally comprise a fourth strain gauge sensor at a backward face, currently hidden by the body 4. Along the passage direction 14, the sensors 20 are at the opposite from the hoper 34.

The strain gauge sensors 20 are arranged in the section of reduced thickness 38. The strain gauge sensors 20 may be arranged at a downstream half of the body 4. More generally, the strain gauge sensors 20 may be arranged at a downstream section of the body 4. Along the passage direction 14, the strain gauge sensors 20 may be at same level. They may be aligned. Along the passage direction 14, the resistive strain gauge sensors 20 may overlap each other.

The resistive strain gauge sensors 20 are fixed to the planar areas 40. In the current embodiment, the section of reduced thickness 38 exhibits three, preferably four, planar areas 40 which form facets perpendicular to one another. The resistive strain gauge sensors 20 may form pair(s) of opposed sensors. The opposed sensors 20 are at opposite locations with respect to the passage direction 14. The sensors 20 are each associated with a dedicated planar area 40. Along the planar areas 40, the body 4 may exhibit a square cross section.

The resistive strain gauge sensors 20 may be identical. Each resistive strain gauge sensor 20 comprises a sensitivity direction 22. As an option, the sensitivity directions 22 are parallel to each other, and along the passage direction 14. This arrangement offers an optimized orientation for sensing bending vibrations generated by the abrasive waterjet flowing through the passage 8. The nozzle 2 and the strain gauge sensors 20 constitute an assembly that can be referred to as “instrumented nozzle”.

The description will now focus on the strain gauge sensor 20 represented in a central position, between the other two. This sensor 20 is currently represented over the passage 8.

The strain gauge sensor 20 comprises a patterned layer 44. The patterned layer 44 forms an active layer, such as an electrically active layer. The patterned layer may comprise a patterned metal film, also designated as metallic foiled patterned layer. Under deformation, the electrical resistance of the patterned layer 44 varies. The patterned layer 44 includes parallel portions 46. The parallel portions 46 may comprise parallel stripes. The parallel portion 46 are preferably parallel sensing portions 46. The sensing portions 46 optionally form a serpentine structure 48. The parallel portions 46 comprise a main portion direction 50. The parallel portions 46 are parallel to each other, and parallel to the portion direction 50. They extend along said portion direction 50. The portion direction 50 is parallel to the sensitivity direction and along the passage direction 14. The portion direction 50 may define the sensitivity direction 22. As an option, some of the sensing portions are inclined with respect to other sensing portions.

Then, the main portion direction is an averaged direction.

The orientation of the parallel portions 46, and notably the orientation of their main portion direction 50 along passage direction 14, increases sensitivity. The strain gauge sensor 20 is more sensitive to deformations. The current orientation increases sensitivity to bending vibrations. The monitoring remains accurate, and wear detection is easier.

In the current embodiment, the nozzle is free of conical section. However, the invention also considers adding a conical section as presented in the previous embodiments.

FIG. 4 provides a schematic illustration of a nozzle 2 for abrasive waterjet cutting in accordance with a preferred embodiment of the invention. The current embodiment is similar to the ones presented in relation with the previous figures.

The nozzle 2 comprises a body 4 and an outer surface 6 which is generally cylindrical. A passage 8 is housed by the body 4. The passage 8 comprises a passage direction 14, an inlet section 16 and an outlet section 18.

The strain gauge sensor 20 is arranged in the planar area 40 of the outer surface 6. It is surrounded by the edge of the flat surface 36. The planar area 40 may be an area with optimal roughness, namely a polished area. Its roughness may be processed in order to increase glue means adhesion. The strain gauge sensor 20 comprises an active layer 44 on an insulation layer 62. The insulation layer 62 comprises a greater surface than the active layer. It is longer and wider. It prevents any electric contact between the active layer 44, and the body 4. Also, it provides isolation of the active layer 44.

The nozzle 2 comprises at least one strain gauge sensor 20 on the body 4. The nozzle 2 and the strain gauge sensor 20 form an assembly that can be referred to as “instrumented nozzle”. The strain gauge sensor 20 is inclined with respect to the passage direction 14 which may correspond to the main axis of the nozzle 2. The sensitivity direction 22 is inclined within a range angle with respect to the passage direction 14. The strain gauge sensor 20 comprises a sensitivity direction 22 which is inclined with respect to the passage direction 14. The nozzle 2 comprises an inclination angle α between the passage direction 14 and the sensitivity direction 22. In the current illustration, the inclination angle α is of 20°. However, the inclination angle α may range from 0° to 30°. The inclination angle α may be of at least 5°. It may be of at most 25°.

An inclination of 0 degrees of the sensing direction 22 with respect to the passage direction 14 is optimal of sensing bending vibrations of the nozzle. A misalignment of 30 degrees may still provide adequate sensing performance.

As an option, the strain gauge sensor 20 is at distance from the downstream end. The strain gauge sensor 20 may be in the upstream half. It may be close to the fixation portion at the cutting head of the abrasive cutting machine. At this location, defined along the passage direction 14, the sensor is exposed to the highest deformations of the body. Thus, higher vibration amplitudes are measured. Furthermore, the sensor is less exposed to abrasive projection. Hence, there is a synergy.

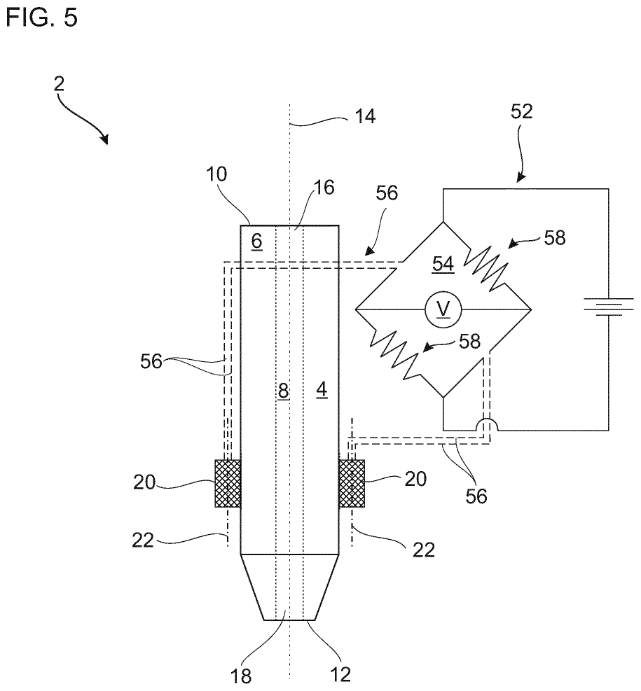

FIG. 5 provides a schematic illustration of a nozzle 2 for abrasive waterjet cutting in accordance with a preferred embodiment of the invention. The current embodiment is similar to the embodiments presented in relation with the previous figures. Generally, the current embodiment provides a half bridge configuration, with opposed sensors.

The nozzle 2 comprises a body 4 and an outer surface 6 which is generally cylindrical. A passage 8 is housed by the body 4. The passage 8 comprises a passage direction 14, an inlet section 16 and an outlet section 18 at the upstream end 10 and at the upstream end 12 respectively. The passage 8 may be an abrasive water passage 8.

The nozzle 2 comprises at least one resistive strain gauge sensor 20, optionally two resistive strain gauge sensors 20. The two strain gauge sensors may be at opposite locations with respect to the passage. All the strain gauges have identical nominal resistance, i.e. at a rest state.

The nozzle 2 may be associated with an electric circuit 52. The electric circuit 52 is electrically connected to the strain gauge sensors 20. It may be connected to an acquisition module (not represented) which is configured for A/D converting the voltage signals. The acquisition module may be connected to a computer in order to process the converted signal(s).

The electric circuit 52 comprises a Wheatstone bridge 54 and a DC voltage/current supplier. A voltmeter V measures a resulting tension V across the Wheatstone bridge 54. Each of the two strain gauge sensors 20 is connected to one dedicated side of the Wheatstone bridge 54 by means of dedicated wires 56. The Wheatstone bridge 54 comprises four electrical resistance components with identical nominal resistance. In the case of FIG. 5, the strain gauge sensors 20 constitute two of said resistance components and can be referred to as active components. The remaining resistance components can be referred to as passive components. In the case of FIG. 5, there are two passive components 58. In the current embodiment, two passive components 58 are provided. Each passive component 58 may comprise an electric resistance equal to the nominal resistances of one of the strain gauges 20, i.e., in a rest state. The rest state may be considered as an unconstrained state. In the case of only one strain gauge sensor 20 connected to the Wheatstone bridge 54, the latter includes three passive components and this configuration is referred to as “quarter bridge”. In the case of FIG. 5, two strain gauge sensors 22 are connected to the opposite sides of a Wheatstone bridge 54, the latter includes two passive components at other opposite sides and this configuration is referred to as “half bridge”. In the case of four strain gauge sensors connected to the Wheatstone bridge 54, the latter does not include passive components and this configuration is referred to as “full bridge”. When the nozzle is provided with a single strain gauge sensor, the electric circuit may form a quarter bridge configuration. The quarter bridge configuration may be deduced from the current figure by removing one of the strain gauge sensor. The removed one may be replaced by a passive component 58.

In the current embodiment, the left strain gauge sensor 20 and the right strain gauge sensor 20 comprise sensitivity directions 22 with are along to the passage direction 14 and/or to one another. Accordingly, the signal obtained from the Wheatstone bridge 54 is more accurate. Two strain gauge sensors 20 in half-bridge configuration may double the sensitivity of the system to bending vibrations, with respect to a single strain gauge sensor 20 in quarter-bridge configuration. Two strain gauge sensors 20 in half-bridge configuration may provide sensitivity to two bending vibrations on orthogonal planes, with respect to a single strain gauge sensor 20 in quarter-bridge configuration. Two strain gauge sensors 20 in half-bridge configuration clean the bridge output signal from interferences, notably temperature induced strain and induced currents, with respect to a single strain gauge sensor 20 in quarter-bridge configuration.

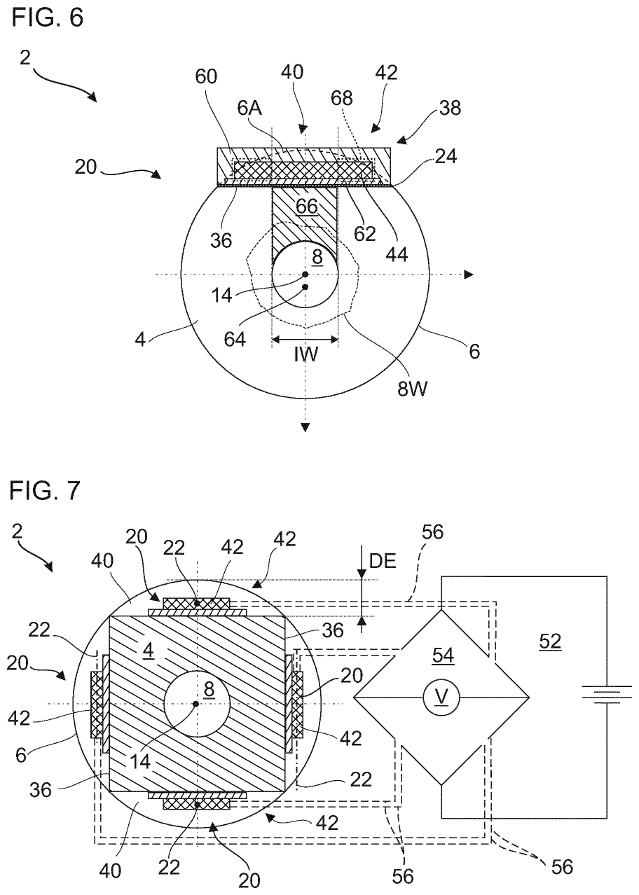

FIG. 6 provides a schematic illustration of a nozzle 2 for abrasive waterjet cutting in accordance with a preferred embodiment of the invention. The current embodiment is similar to the ones presented in relation with the previous figures, notably FIGS. 2 and 4. The current illustration is a through cut, perpendicularly to the passage direction 14. A dashed line 8 W around the passage 8 represents the passage in a worn state.

The nozzle 2 comprises a body 4 and an outer surface 6 which is generally cylindrical. The passage 8 is housed by the body 4. The passage 8 comprises, an inlet section and an outlet section at the upstream end and at the upstream end respectively. The resistive strain gauge sensor is maintained by an adhesive layer 24 or glue covering the flat surface 36 of the planar area 40.

The nozzle 2 comprises a protective layer 60. The protective layer 60 covers the at least one resistive strain gauge sensor 20. The protective layer 60 forms a mask on the resistive strain gauge sensor 20.

The planar area 40 may form a pocket filled by the protective layer 60. The protective layer 60 may comprise polymer.

The protective layer 60 may comprise epoxide. The epoxide material offers a relevant protection in the context of abrasive waterjet cutting, where the expected life span of the nozzle may range from 50 hours to 150 hours. In addition, the sensor 20 as the layer 60, are at least partially buried in the section of reduced thickness 38, due to the shape of the recess 42. The outline of the circular section 6A of the outer surface 6 is represented in doted lines.

The strain gauge sensor 20 comprises an active layer 44. The active layer 44 may be an electrically active layer. The active layer 44 may be a sensing layer. It may comprise metal, or graphite. It comprises resilient electrical conducting means whose deformation implies an electric resistance variation. The active layer 44 may be a metallic foiled patterned layer 44. The strain gauge sensor may comprise an insulating layer 62. The insulating layer 62 may be an electrically insulating layer 62. The insulating layer 62 is between the outer surface 6 and the electrically active layer 44. The planar surface 36 of the nozzle body, the adhesive layer 24, the insulating layer 62, the active layer 44 and the protective layer 60 form a laminate structure.

Along the planar area 40, the neutral axis 64 is offset from the passage direction 14, albeit the passage 8 is generally at the centre of the body 4. The body 4 comprises a passage connection 66 joining the passage 8 to the planar area 40 of the outer surface 6. The passage connection 66 and the passage 8 are of the same width, i.e., the inner width IW. The passage connection 66 connects the passage 8 and the strain gauge sensor 20. The passage connection 66 may be considered as a portion of maximum deformation 66. During operation, along the strain gauge sensors 20, it exhibits the highest extension and compression amplitudes. Shear constraints are high as well. The strain gauge sensor 20 extends over at least the whole width of the passage connection 66. Then, the sensor 20 offers an accurate measure of vibrations.

More precisely, the active layer 44 extends at least on 50% of the width IW of the passage connection 66. Then, the active layer 44 is exposed to bending deformations of the passage connection 66; and hence of the body 4. As an option, the active layer 44 extends on at least the whole width of the passage connection 66. Accordingly, along the strain gauge sensors 20, the strain gauge sensor 20 benefits from the maximum deformation potential of the passage connection 66. Then the sensor 20 is exposed to a spread deformed zone, and optimizes coverage. It may exhibit greater resistance variation under vibrations. In order to increase further the resistance variation, the active layer 44 may comprise at least one a side portion 68 extending beyond the passage connection 66.

The current embodiment only represents a single sensor 20. However, the skilled person will readily adapt the current teaching to a configuration with two or more strain gauges sensors. For instance, the protective layer 60 may cover several strain gauge sensors.

FIG. 7 provides a schematic illustration of a nozzle 2 for abrasive waterjet cutting in accordance with a preferred embodiment of the invention. The current embodiment is similar to the nozzles detailed in relation with the previous figures. The current figure may be similar to a through cut of FIG. 3, through the sensors 20.

The nozzle 2 comprises a body 4 and an outer surface 6 which is generally cylindrical. A passage 8 is housed by the body 4. The passage 8 comprises a passage direction 14, an inlet section 16 and an outlet section.

In the current embodiment, the nozzle 2 receives four resistive strain gauge sensors 20 which are all connected to a Wheatstone bridge 54 of an electric circuit 52. The resistive strain gauge sensors may be angularly distributed about the passage 8, and notably the passage direction 14. The electric circuit 52 may form a full bridge configuration with the four strain gauge sensors 20. The strain gauge sensors 20 comprise sensitivity directions 22. At least one sensitivity direction is along the passage direction 14. Other wiring 56 may be considered.

Optionally, at least two sensitivity directions 22, for instance of two opposite sensors 20, are along the passage direction 14. Two other sensitivity directions 22 are generally inclined with respect to, or perpendicular to, the passage direction 14. The sensitivity directions 22 parallel to the passage direction 14 may be configured for providing a double sensitivity as their sensors are at opposite faces. The sensitivity directions 22 orthogonal to the passage direction 14 may be configured for providing a reference, for cleaning the bridge output signal from interferences, notably temperature induced strain and induced currents. Optionally, all sensitivity directions 22 are along the passage direction.

In one embodiment, each sensitivity direction 22 is along, optionally parallel to, the passage direction 14. Then, the sensitivity may be increased further.

The Wheatstone bridge 54 is fixed to the abrasive waterjet cutting machine, at distance from the nozzle. It may be provided at computing means.

The body 4 comprises at least one recess 42. In the current illustration, four recesses 42 are provided; each associated to one strain gauge sensor 20. The recesses 42 are associated with the planar areas 40. The recesses 42 sink toward the passage 8. The depths DE of the recesses 42 are greater than the thicknesses of the patterned layers 44. Each active layer 44 is thinner than a recess depth DE. Each depth DE may be a maximum depth or an average depth of a recess 42. The depths DE are measured perpendicularly to the flat surfaces 36; and/or with respect to the active layer thickness. The flat surfaces 36 are adjacent. They may touch each other and define a square cross section. As an option, at least one or each recess 42 comprises a recess depth DE which is at least two time greater than the combined thicknesses of a thickness of a patterned layer 44 and a thickness of an insulating layer, and optionally an adhesive layer thickness.

The left and right strain gauge sensors 20 comprise sensitivity directions 22 which are perpendicular to the others. The left and right sensitivity direction 22 are perpendicular to the passage direction 14, and/or the sensitivity directions 22 of the upper and lower strain gauge sensors 20. Then, the left and right strain gauge sensors 20 with transversal sensitivity directions 22 are less sensitive to vibrations. They may be used as a reference in the Wheatstone bridge 54. They may be used for comparison purposes. These the strain gauge sensors 20 filter temperature variations or electrical interferences; at least.

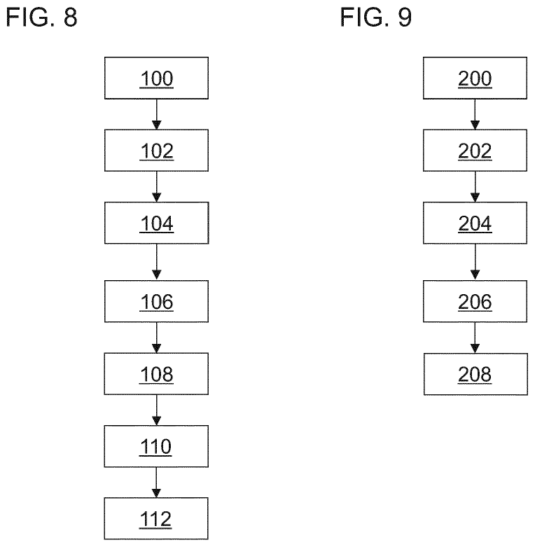

FIG. 8 provides a schematic illustration of a diagram of a manufacturing method with an abrasive waterjet cutting machine with a nozzle in accordance with the invention. The nozzle may be in accordance with any of FIGS. 1 to 7, and combinations thereof.

The manufacturing method comprises the following steps, optionally executed as follows:
providing 100 a nozzle for abrasive waterjet cutting;
providing 102 at least one strain gauge sensor comprising a sensitivity direction;
machining 104 in order to form a planar area on the outer surface, at step fixing the strain gauge sensor is fixed on said planar area;
smoothing 106 a sensor area of the outer surface, at step fixing the at least one strain gauge sensor being fixed at said sensor area;
aligning 108 the sensitivity direction along the passage direction;
fixing 110 the at least one resistive strain gauge sensor on the outer surface.
applying 112 a protective layer on the at least one strain gauge sensor and on the outer surface.

At the step of providing 100 a nozzle, said nozzle may be a green nozzle. At a later step, the green nozzle may be sintered, for instance after the step of machining 104 and/or after the step of smoothing 106, or polishing.

The step of fixing 110 comprises gluing the strain gauge sensor on the outer surface. After the step of smoothing 106, the sensor area; notably the planar area; comprises a roughness Ra ranging from 0.2 μm to 6 μm. This offers a relevant gluing fixation for the sensor which vibrates at various frequencies. During the step of smoothing 106, the area becomes smother. The step of smoothing 106 may comprise a step of grinding.

At the step of applying 112, a polymer layer or a polymer film is provided on each strain gauge sensor. The layer may comprise epoxide. It may form a water tight layer.

During cutting operation, the instrumented nozzle vibrates. As a consequence, the downstream end 12 vibrates. The vibration might be the sum of several vibration contributions. The output signal of the Wheatstone bridge 54 contains information about the bending vibrations of the nozzle. The frequency content of the bridge signal might be analysed by means of a Fourier Transform. As an example, FIG. 12 shows the power spectral density of the signal measured during operation. The first bending vibration of the new instrumented nozzle corresponds to the left peak. The frequency of the peak corresponds to the mode frequency of the correspondent first vibration mode. In the worn state, the mode frequencies change with respect to the new state. As the wear of the instrumented nozzle progresses, the inner passage becomes larger, hence its mode frequencies become higher. As a consequence, the peak of the first bending vibration shifts towards higher frequencies. For instance, a frequency shift of 50 Hz may be observed, between new and worn state. The right peak corresponds to the first bending vibration of the worn nozzle. The cumulated shift of the peak at any instant can be used as indicator of the wear status and residual life of the nozzle.

FIG. 9 provides a schematic illustration of a diagram of a wear monitoring process of an abrasive waterjet cutting nozzle, in accordance with the invention. The nozzle may be in accordance with any of FIGS. 1 to 7, and combinations thereof.

The process comprises the following steps:
providing 200) a nozzle with a strain gauge sensor;
measuring 202, by means of the strain gauge sensor, vibration data of the nozzle during cutting operation;
identifying 204 a natural frequency of the nozzle in the vibration data;
identifying 206 a natural frequency shift of said natural frequency;
generating 208 a wear signal if the natural frequency shift meets a predefined condition.

During the step of measuring 202, the waterjet is flowing through the nozzle whilst cutting operation of a work piece could be either in progress or not. A pressurized abrasive waterjet flows through, and is guided by the passage. The workpiece is not an essential aspect. The wear state may be assessed when the cutting system is free of workpiece.

The step of identifying 204 the natural frequency may comprise computation of Fourier Transform of the time signal and detecting a frequency peak; for instance: the first natural frequency, or the second natural frequency. As an alternative, the third or the fourth natural frequency may be considered.

The step identifying 206 a natural frequency shift may be the identification of frequency shift of the frequency peak. The step of identifying 206 may be executed during the step of measuring 202, preferably continuously.

The wear monitoring process may comprise the step of generating 208 a wear signal if the natural frequency shift reaches a frequency shift threshold, and/or if the predefined condition may be a frequency increase.

The former criterions may be a frequency value or frequency increase of at least: 50 Hz, or 150 Hz. As an option, the nozzle comprises a rest natural frequency at a rest state which is higher than the natural frequency identified during the step of identifying a natural frequency. The latter natural frequency may be a constrained natural frequency, or an operation natural frequency. The rest natural frequency is at least: two times, or three times, higher than the constrained natural frequency.

Optionally or alternatively, the process comprises the following steps:
providing a nozzle,
cutting a workpiece;
measuring first vibration data with the sensor; then
identifying a first natural frequency of the nozzle in the first vibration data,
measuring second vibration data with the sensors;
updating said first natural frequency;
generating a wear signal if the updated first natural frequency meets a change condition.

The invention relies on accurate data which simplifies computing. Indeed, it focusses on a natural frequency, which is an accurate piece of data, and follows up its evolution. Since there is a tight correlation between the natural frequency variation and the wear state, it is convenient to decide on when replacing the worn nozzle. The amount of data which is used is reduced, such that it requires limited computing resources. On top of this, the strain gauge sensor provides reliable vibration data, which are accurate enough for obtaining the natural frequency, and the associated gradual shift.

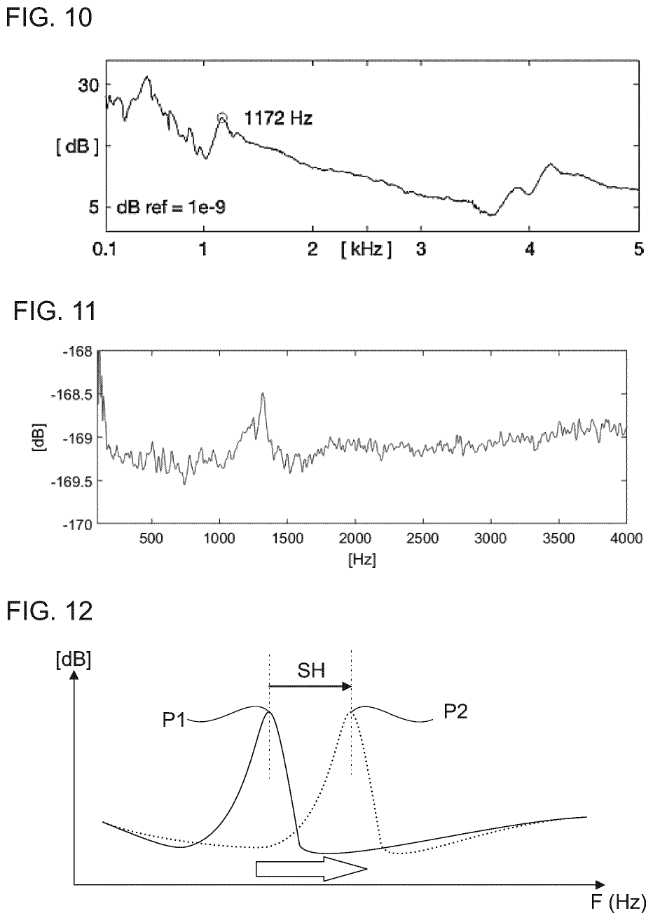

FIG. 10 provides a power spectral density of vibrations of a nozzle, during operation. The vibrations are measured with an accelerometer.

The vibration data comprise a vibration combination of the rigid vibrations, and the nozzle vibrations due to its own deformations. The rigid vibrations may comprise vibrations transmitted by the abrasive waterjet head itself. The latter vibrations do not reflect the wear state of the nozzle.

FIG. 11 provides a schematic illustration of a power spectral density of the vibrations during cutting operations of a nozzle in accordance with the invention.

The instrumented nozzle may be not perfectly axial-symmetric about the passage direction; notably about the passage axis. The instrumented nozzle, as a continuous body, and under the constraint of its fixture to the cutting head of the abrasive waterjet cutting system, may exhibit a first vibration mode as the one shown in FIG. 1. As it can be seen, the correspondent mode shape corresponds to a bending oscillation. Hence, the first vibration mode of the instrumented nozzle can be referred to as its first bending vibration mode. In the case of a non-perfectly axial-symmetric instrumented nozzle, its second vibration mode might occur at a mode frequency that is very close (<10 Hz difference) with respect to the mode frequency of the first vibration mode, and the mode shape of the second vibration mode might be a bending oscillation that is orthogonal with respect to the mode shape of the first vibration mode. Under this circumstance, the first two vibration modes of the instrumented nozzle might be referred to as its twin bending modes.

The vibration might be the sum of several vibration contributions. The vibration might be measured at a certain point of the instrumented nozzle. For example, an accelerometer might be attached near its tip, to measure the vibration at the correspondent point. The frequency content of the correspondent signal might be analysed by means of a Fourier Transform, to help distinguishing the different vibration contributions. As an example, FIG. 10 shows the power spectral density of the signal measured during operation by an accelerometer, attached near the tip of a nozzle. As it can be seen, several maxima appear, of which: one (notably the one at 1172 Hz) is the vibration contribution that corresponds to the first (and possibly the second twin) bending mode of the nozzle; others are vibration contributions due to the vibrations of further components of the abrasive waterjet cutting system, that are transmitted through the constraint as rigid oscillations of the nozzle 2.

The at least one strain gauge sensor of the instrumented nozzle is not sensitive to the rigid vibrations of the instrumented nozzle as these do not entail deformations. Hence, the power spectral density of its signal during operation appears as shown in FIG. 11. With respect to the accelerometer of FIG. 10, here the rigid vibrations disappear and only the bending vibrations are still present, at about 1250 Hz. The strain gauge sensor generally filters vibrations, on keeps data related to the nozzle as such. The strain gauge sensor improves accuracy.

The current curve thereby illustrates the frequency peak corresponding to the first natural frequency, under constraint, of the nozzle.

FIG. 12 provides a schematic illustration of natural frequency shift on power spectral density curves of the vibrations during cutting operations of a nozzle in accordance with the invention. The curve in solid line corresponds to a new nozzle, the curve in dashed line corresponds to a worn nozzle.

During abrasive waterjet cutting operation, the nozzle is worn by the repetitive passage of the abrasive particles. Then, the shape of the passage changes. It becomes wider. There is a material loss which influences the stiffness mass distribution of the nozzle, thereby modifying the vibration behaviour of the nozzle. As a corollary, the natural frequencies changes. The present illustration shows a peak P1 corresponding to the first natural frequency when the nozzle is new, or unworn state. The other peak P2 correspond to the first natural frequency when the nozzle is worn; for instance, after 50 hours, our 150 hours of cutting operation.

During cutting operation, the natural frequency, optionally the first natural frequency, gradually changes. It may increase. A natural frequency shift SH is detected and monitored. When the natural frequency shift SH meets a specific condition, it is concluded that the nozzle is in a worn configuration. The condition may be an increase of at least: 50 Hz, or 100 Hz, or 150 Hz, or 200 Hz.

In a general manner, features defined in relation with a resistive strain gauge sensor also apply to each strain gauge sensor, and vice-versa.

The invention considers combining the different embodiments with each other. Features from one embodiment are combined with features of other embodiments, except where the contrary is explicitly mentioned. Features described in relation with one sensor of an embodiment may apply to all other sensors of said embodiment, and to other embodiment. Each nozzle may be associated with an electric circuit comprising a Wheatstone bridge, as described in relation to FIGS. 5 and/or 7.

It should be understood that the detailed description of specific preferred embodiments is given by way of illustration only, since various changes and modifications within the scope of the invention will be apparent to the person skilled in the art. The scope of protection is defined by the following set of claims.

1. A nozzle for abrasive waterjet cutting, the nozzle comprising:
a body comprising an outer surface;
a passage through the body,
said passage comprising: in inlet section, an outlet section and a passage direction,
a said passage being configured for guiding an abrasive water et;
at least one strain gauge sensor comprising a sensitivity direction, with the sensitivity direction oriented along the passage direction.

2. The nozzle in accordance with claim 1, wherein the nozzle comprises an inclination angle α between the passage direction and the sensitivity direction which is of at most 30″.

3. The nozzle in accordance with claim 1, wherein the strain gauge sensor comprises a patterned layer and an insulating layer, the strain gauge sensor optionally being a resistive strain gauge sensor.

4. The nozzle in accordance with claim 3, wherein the patterned layer comprises a serpentine structure with parallel sensing portions which comprise a main portion direction, said portion direction being along to the passage direction.

5. The nozzle in accordance with claim 1, wherein the body comprises a conical section at the outlet section; along the passage, the at least one strain gauge sensor is at distance from the conical section.

6. The nozzle in accordance with claim 5, wherein the conical section defines a geometrical conical surface extending along the at least one strain gauge sensor, said at least one strain gauge sensor being within the geometrical conical surface, perpendicularly to the passage direction the at least one strain gauge sensor is optionally at distance from geometrical conical surface.

7. The nozzle in accordance with claim 1, wherein the outer surface is generally cylindrical and comprises a planar area, the strain gauge sensor being arranged on said planar area.

8. The nozzle accordance with claim 7, wherein the planar area defines a recess on the body, the recess comprising a recess depth which is at least two time greater than the combined thicknesses of a thickness of the patterned layer and a thickness of the insulating layer, and optionally an adhesive layer thickness.

9. The nozzle in accordance with claim 1, wherein the at least one strain gauge sensor comprises a first strain gauge sensor with a first sensitivity direction, and a second strain gauge sensor with a second sensitivity direction, the first strain gauge sensor and the second strain gauge sensor optionally being arranged at radially opposite positions with respect to the passage.

10. The nozzle in accordance with claim 9, wherein the planar area is a first planar area, the outer surface further comprising a second planar area, the second strain gauge sensor being fixed on said second planar area.

11. The nozzle in accordance with claim 1, wherein the nozzle comprises a protective layer covering the at least one strain gauge sensor, optionally in order to form a nozzle laminate structure.

12. The nozzle in accordance with claim 11, wherein the protective layer (60) comprises polymer, optionally epoxide.

13. A wear monitoring process of a nozzle for abrasive waterjet cutting, the wear monitoring process comprising:
providing (200) a nozzle comprising:
a body comprising an outer surface;
a passage through the body, said passage comprising a passage direction and being configured for guiding an abrasive waterjet,
a strain gauge strain gauge sensor comprising a sensitivity direction oriented along the passage direction,
measuring, by means of the strain gauge sensor, vibration data of the nozzle during cutting operation;
identifying a natural frequency of the nozzle in the vibration data;
identifying a natural frequency shift of said natural frequency;
generating a wear signal if the natural frequency shift meets a predefined condition.

14. The wear monitoring process in accordance with claim 13, wherein the predefined condition comprises a frequency shift of at least: 1 Hz, or 50 Hz.

15. The wear monitoring process in accordance with claim 13, wherein the nozzle comprises a rest natural frequency at a rest state which is higher, preferably at least twice as height, than the natural frequency identified during the step of identifying a natural frequency.

16. A manufacturing method of a nozzle for abrasive waterjet cutting, the method comprising:
providing a nozzle for abrasive waterjet cutting, the nozzle comprising:
a body comprising an outer surface;
a passage through the body,
a said passage comprising an inlet section, an outlet section, and a passage direction,
a said passage being configured for guiding an abrasive waterjet;
providing at least one strain gauge sensor comprising a sensitivity direction;
aligning the sensitivity direction 1 along the passage direction; and
fixing the at least one strain gauge sensor on the outer surface.

17. The manufacturing method in accordance with claim 16, wherein the manufacturing method further comprises a step machining in order to form a planar area on the outer surface, at the step of fixing the strain gauge sensor is fixed on said planar area.

18. The manufacturing method in accordance with claim 16, wherein the step of fixing comprises gluing the strain gauge sensor on the outer surface.

19. The manufacturing method in accordance with claim 16, wherein after the step of fixing, the manufacturing method further comprises a step applying a protective layer on the at least one strain gauge sensor and on the outer surface.

20. The manufacturing method in accordance with claim 16, wherein the method further comprises a step smoothing a sensor area of the outer surface, at the step of fixing the at least one strain gauge sensor being fixed at said sensor area.

21. A method comprising:
sensing, by at least one strain gauge sensor comprising a sensitivity direction, vibrations of a nozzle for abrasive waterjet cutting, said nozzle comprising:
a body comprising an outer surface,
a passage along the body,
a said passage comprising: an inlet section, an outlet section, and a passage direction;
said passage being configured for guiding an abrasive waterjet;
the nozzle optionally being in accordance with claim 1.

22. The method in accordance with claim 21, wherein the at least one strain gauge sensor comprises at least two strain gauge sensors with sensitivity directions along to the passage direction.

23. The method in accordance with claim 21, wherein the at least one strain gauge sensor is electrically connected to a Wheatstone bridge.
